(19) United States
(12) Patent Application Publication
(10) Pub. No.: US 2015/0068044 A1
(43) Pub. Date: Mar. 12, 2015

(54) HANDHELD LEATHER EDGE BEVELER

(71) Applicant: Weaver Leather, LLC, Mt. Hope, OH (US)

(72) Inventor: James Jeremiah Ian Watt, Coalinga, CA (US)

(73) Assignee: Weaver Leather, LLC, Mt. Hope, OH (US)

(21) Appl. No.: 14/021,427

(22) Filed: Sep. 9, 2013

(51) Int. Cl. B26B 5/00; B25G 1/10; B26B 27/00

(52) U.S. Cl. CPC B26B 5/00; B26B 27/00; B25G 1/10
USPC 30/172; 30/169; 29/446; 29/426.2

(57) ABSTRACT

An edge beveling tool for working leather including a handle; a cutting member comprising an arm with first and second ends, cutting surface(s) being provided on the second end, and a spring assembly for removably engaging the cutting member with the handle. The first end of the cutting member is inserted into a slot defined in the handle and is engaged by the spring assembly. The spring assembly is a spring clip which urges the first end of the cutting member into contact with an interior wall of the handle. When it is desired to replace the first cutting member with a second cutting member having a different cutting profile, the first cutting member is grasped and pulled out of the slot. A first end of the second cutting member is then inserted into the slot where the spring clip urges it contact with the interior wall of the handle.

### TECHNICAL FIELD

This invention relates generally to tools used for working leather. In particular the present invention relates to a leather edge beveler useful for removing the square edges on a piece of leather when making straps or belts or the like. Specifically, the present invention is a handheld leather edge beveler which comprises a handle with an engagement means provided therein and which is useful for attaching a wide array of different edger blades thereto.

### BACKGROUND INFORMATION

When craftsman are making belts, straps and other articles from leather they typically have to cut the leather with a sharp knife. This tends to create a sharp edge at each of the upper and lower corners of the cut face on the leather strip. If the craftsman is making a belt, for example, these sharp edges or corners will tend to cause discomfort in the end-user and so it has become customary to round off the sharp edges, i.e., to bevel the corners. This is done by cutting a strip of leather off one or both of the upper and lower corners of the leather workpiece. The tool used for this purpose is known as an edge beveler. Some edge bevelers are used on a commercial scale and are at least somewhat mechanized. These commercial-type edge bevelers are typically mounted on a work surface and include rotating heads having cutting surfaces thereon. The tools are capable of rapidly and easily cutting one or both of the upper and lower corners of a workpiece simply by puffing the workpiece through a gap between the rotating heads.

Other edge bevelers are handheld devices that are used by individual craftsman and hobbyists. It is this type of edge beveler that is the subject of the present disclosure. There are a wide variety of handheld edge bevelers available on the market. Each edge beveler includes a special type of blade that is fixedly mounted in a handle. Each blade has a specific cutting profile and is of a specific size. In order to distinguish between the different sizes of blade with the same cutting profile, handheld edge bevelers are given a number, e.g. Number 2, Number 3, or Number 4. The craftsman will select his or her tool firstly based on the type of edge he or she wishes to provide on the end product. They will then select the style of the cutting profile on the blade that will produce the desired effect. Some of the specific cutting profiles are Bisonette edgers which include a hole with two rounded cutting profiles. These edgers can round over the sharp corners on the leather workpiece if the tool is pushed or pulled along the leather. Round Bottom edgers have a single rounded cutting profile or blade which again rounds over the corners of the leather, but only if the edge beveler is pushed along the leather. Another type of cutting profile is a Vizzard edge beveler which has a rounded profile with an octagonal shank. This edger gives the corner a different appearance to the previous two edgers. Edge shavers and flat edge bevelers have a blade profile which will cut a flat or angled piece from the corners of the leather workpiece. Once the particular style of edge beveler is selected, the craftsman will decide on the size of bevel he or she wishes to cut at the corners and will then select the appropriately numbered tool for the job. So, for example, the craftsman may select a No. 2 Bisonette edge beveler or a No. 4 Vizzard edge beveler.

Each project undertaken by a craftsman will require different styles and sizes of edger beveler to create the desired aesthetic in the end product. A craftsman will therefore have to own a wide variety of differently styled and differently sized edge bevelers to practice his or her craft.

This issue has been addressed by some manufacturers by providing a single handle with a plurality of differently sized or configured cutting members. For example, Springfield Leather Company of Springfield, Mo., USA sells an edger set which comprises a handle and a plurality of cutting members. The cutting members each have a shaft which is configured at one end to be received in a chuck-type mechanism mounted at one end of the handle. The cuffing members not currently engaged with the handle are stored in a chamber in the rear of the handle.

Leathercraft4u of Yannawa, Bangkok, Thailand sell a “3 in 1 Edge Beveler” which again comprises a handle with a chuck-type mechanism mounted at one end. A plurality of cutting members having different blade sizes are sold with the handle and each cuffing member includes a shaft configured to be selectively engaged in the chuck-type mechanism.

While the edge bevelers referenced above work adequately, the chuck-type mechanism is relatively expensive to incorporate in the tool and has a tendency to work loose as the tool is used. This results in the cutting member not being tightly retained with the handle and this may cause the leather end product to have bevels cut therein which are not as aesthetically pleasing as they could have been if the engagement between the cutting member and handle was secure.

There is therefore a need in the art for an improved edge beveler which addresses these issues of the prior art.

### SUMMARY

An edge beveling tool for working leather, a kit and a method of changing an edge beveling tool is disclosed. The edge beveling tool includes a handle; a cutting member comprising an arm with first and second ends, cutting surface(s) being provided on the second end; and a spring assembly for removably engaging the cutting member with the handle. The first end of the cutting member is inserted into a slot defined in the handle and is engaged by the spring assembly. The spring assembly is a spring clip which urges the first end of the cutting member into contact with an interior wall of the handle. When it is desired to replace the first cutting member with a second cutting member having a different cutting profile, the first cutting member is grasped and pulled out of the slot. A first end of the second cutting member is then inserted into the slot where the spring clip urges it contact with the interior wall of the handle.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims.

FIG. 1 is a perspective view of a PRIOR ART edge beveler which includes a cutting member that is fixedly engaged with a handle;

FIG. 2 is a perspective view of a second PRIOR ART edge beveler which includes a cutting member that is releasably engaged in a chuck-type mechanism mounted on a handle;

FIG. 3 is a perspective view of an edge beveler in accordance with one aspect of the present invention;

FIG. 4 is a perspective view of an exemplary edge beveling kit in accordance with another aspect of the present invention;

FIG. 5 is a cross-section taken along line 5-5 of FIG. 3.

Similar numbers refer to similar parts throughout the drawings.

### DETAILED DESCRIPTION

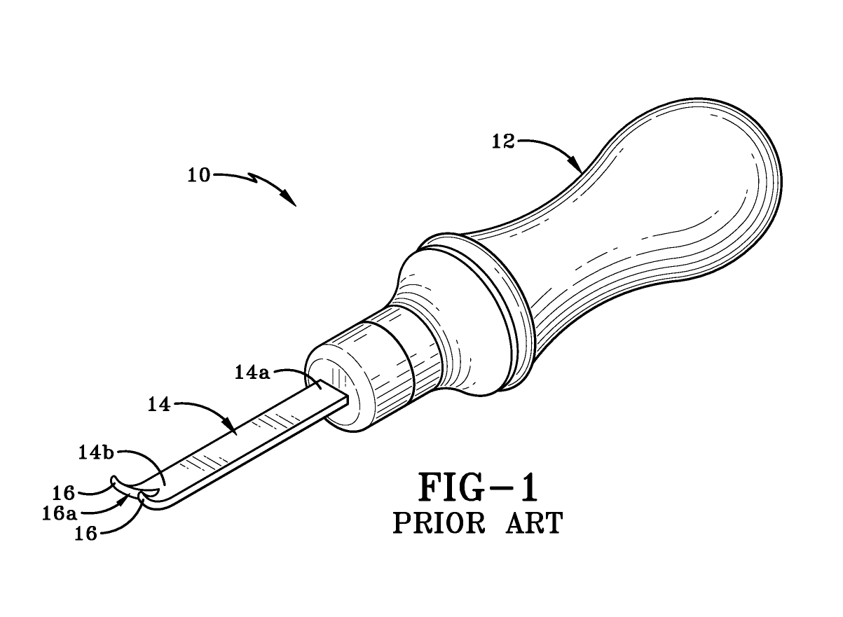

Referring to FIG. 1, there is shown a PRIOR ART edge beveler, generally indicated at 10. Edge beveler 10 comprises a handle 12 and a cutting member 14. Cutting member 14 has a first end 14a that is engaged with handle 12. A second end 14b of cutting member 14 has a pair of tines 16 that are separated from each other by a gap (not numbered). The inside surfaces of each tine 16 is provided with a cutting surface 16a or blade. When edge beveler 10 is pulled along a sharp edge of a piece of leather, the cutting surfaces 16a on tines 16 will cut away a section of the leather, thereby beveling the corner thereof. A gap (not numbered) is defined between the cutting surfaces 16a of the two tines 16. This gap determines the size of the bevel that will be cut into an edge of a leather workpiece. Edge beveler 10 shown herein is one in which cutting member 14 is fixedly engaged with handle 14 by some suitable means such as utilizing an adhesive applied between first end 14a and the end of handle 12 or by welding cutting member 14 to a metal cap and then adhesively attaching or screwing the metal cap onto the end of handle 12.

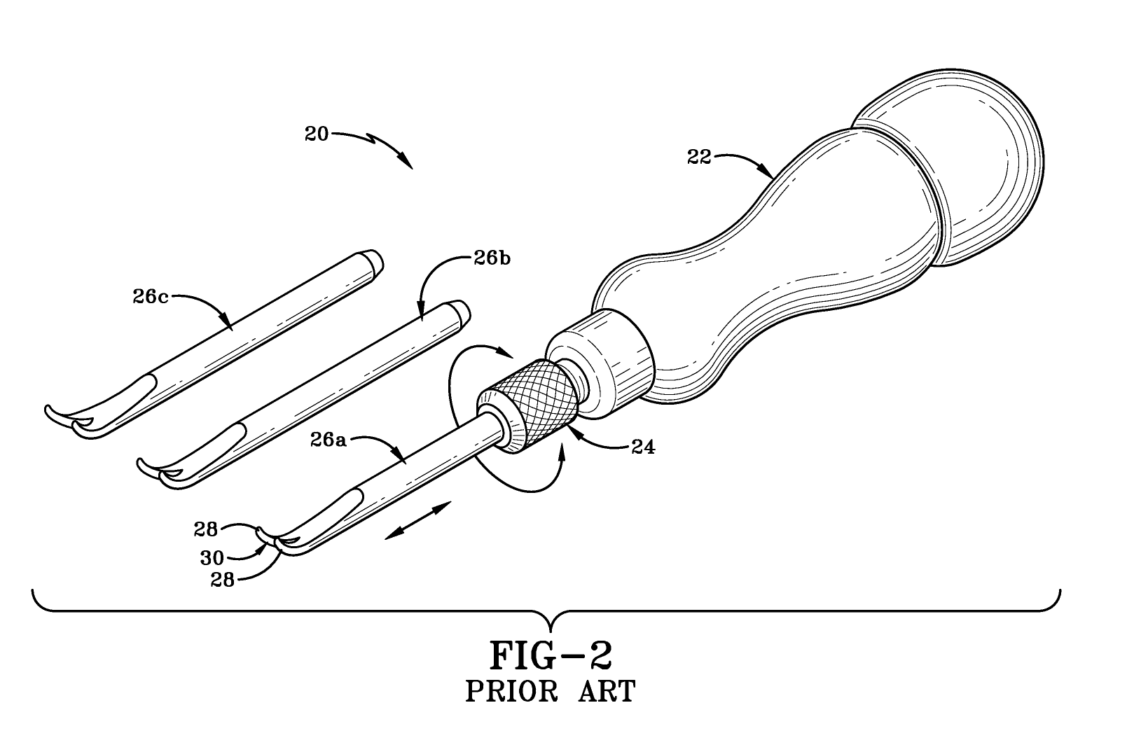

FIG. 2 shows a second PRIOR ART edge beveler generally indicated at 20. Beveler 20 includes a handle 22 with a chuck-type mechanism 24 engaged therewith. A plurality of cutting members 26a, 26b, 26c are provided for selective engagement with chuck-type mechanism 24. Each of the cutting members 26a, 26b, and 26c includes tines 28a, 28b, 28c at one end with cutting surfaces 30a, 30b, 30c disposed on the interior surfaces of each respective pair of tines. A gap is defined between each pair of cutting surfaces 30a-30c and this gap is different for each cutting member 26a-26c. The craftsman will select which of cutting members 26a, 26b or 26c to use for a particular edging task and will then engage the selected member with chuck-type mechanism 24.

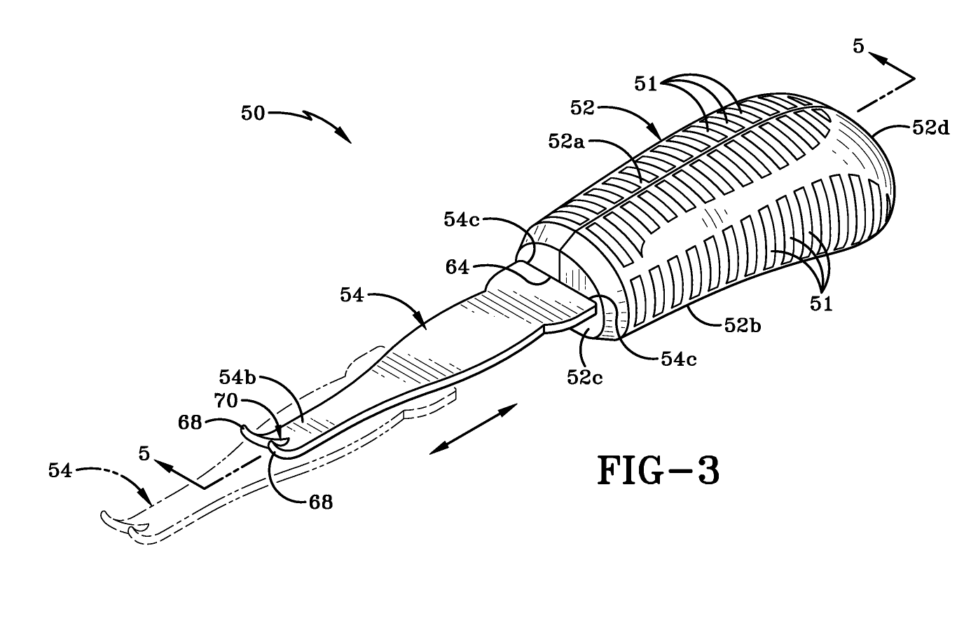

Referring now to FIGS. 3-5 there is shown an edge beveling kit in accordance with one aspect of the present invention, with the beveler being generally indicated at 50. Edge beveler 50 comprises a handle 52 and a cutting member 54. In one aspect of the invention, additional cutting members 56, 54 are also provided for engagement with handle 52.

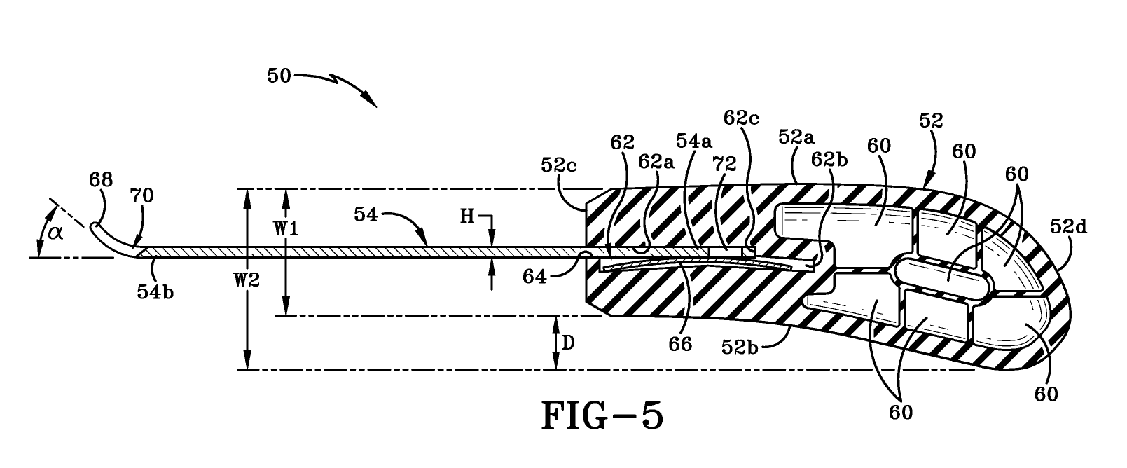

Handle 52 is ergonomically shaped and includes a top wall 52a, a bottom wall 52b, a first end 52c and a second end 52d. Handle 52 has a longitudinal axis “Y” extending between first and second ends 52c, 40d. Preferably, handle 52 is fabricated in two sections which are then secured together by suitable means. Preferably, handle 52 is fabricated by injection molding two plastic halves of handle 52 which are then secured together by heat welding for example. Top wall 52a is gently curved (as shown in FIG. 3) and is configured to sit easily against a craftsman's palm when he or she is gripping handle 52. The curvature of top wall 52a is such that it is a gentle convex curve. Similarly, bottom wall 52b is gently curved and is configured to provide a seat for the craftsman's fingers and thumb which curl around the curved sides regions of top wall 52a) and under bottom wall 52b. The curvature of bottom wall 52b is a gentle concave curve. Front end 52c is generally planar and rear end 52d is convexly curved. As shown in FIG. 5, the width “W1” of handle 52 proximate first end 52c and the portion of handle 52 adjacent first end 52c is smaller than the width “W2” of second end 52d and the portion of the handle 52 that is adjacent second end 52d. Additionally, handle 52 tapers from second end 52d toward first end 50e and the bottom region of second end 52d is spaced a distance “D” lower than the bottom region of first end 52c.

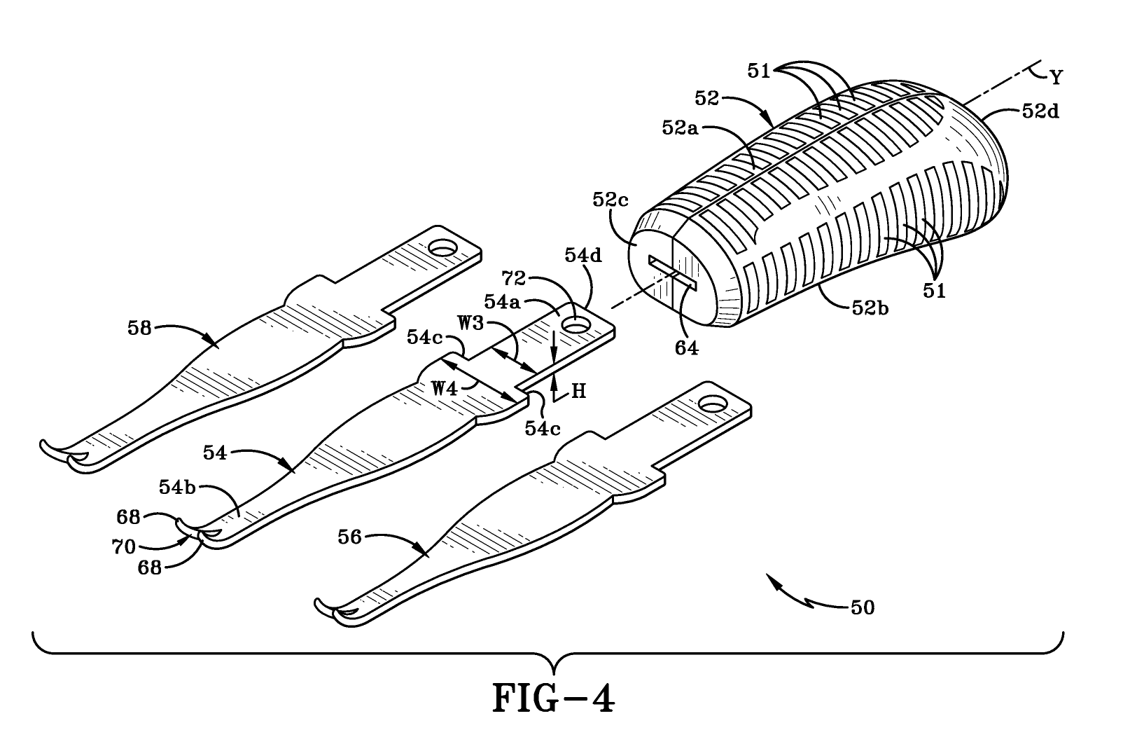

Handle 52 includes a plurality of cut-outs 60 therein to reduce the overall weight of handle 52 and therefore make the tool light and easy to use. Handle 52 further defines a slot 62 therein. Handle 52 defines an opening 64 (FIG. 4) to slot 62 in first end 52c. Slot 62 comprises a first chamber 62a and a second chamber 62b that are in communication with each other. First chamber 62a is in communication with opening 64.

In accordance with one aspect of the invention, a spring clip 66 is disposed within slot 62. A first end of spring clip 66 is disposed within first chamber 62a and a second end of spring clip 66 is disposed within second chamber 62b. The purpose of spring clip 66 will be described further herein.

In accordance with another aspect of the invention, handle 52 preferably is provided with some type of textural element which aids in the craftsman gripping handle 52. In the figures attached hereto that textural element comprises a plurality of ridges or grooves 51 provided at intervals along the exterior surface of handle 52. Preferably the ridges or grooves 51 are oriented substantially at right angles to longitudinal axis “Y”. It will be understood that these textural elements may be omitted.

Each cutting member 54, 56, 58 is substantially identical except for the configuration of the tines on the end thereof as well as the shape of the cutting profile of the blades disposed between the tines. Because of the similarity between cutting members 54-58, only cutting member 54 will be described further herein. It should be understood, however, that the description applies equally to the other cutting members 56, 58. Cutting member 54 has an arm with a first end 54a and a second end 54b. The arm is substantially flattened along its length with the exception of the tines 68. In the type of cutting member 54 illustrated herein the tines 68 are disposed at an angle a relative to the rest of the arm. Tines 68 are spaced a distance apart from each other and include a blade or a cutting surface 70 on each interior side edge of each tine 68.

Referring to FIG. 4, first end 54a of cutting member 54 has a width “W3” and a height “H” which is substantially complementary to that of opening 64 in handle 52. First end 54a is configured to be received through opening 64 and into slot 62. In particular, first end 54a slides into first chamber 62a of slot 62 and is engaged by spring clip 66. Spring clip 66 urges first end 54a into abutting contact with the interior surface of handle 52 which defines slot 62 and thereby keeps first end 54a interlockingly engaged with handle 52.

The arm of cutting member 54 includes a pair of shoulders 54c which are disposed adjacent first end 52c of handle 52 when cutting member 54 is engaged therewith. The width “W4” of the arm in the region of shoulders 54c is greater than the width “W3” and is therefore such that the arm is prevented from sliding further inwardly through opening 64 in handle 52. Shoulders 54c thus limit the longitudinal travel of cutting member 54. The longitudinal travel of cutting member 54 is further arrested between the edge 54d of cutting member 54 abuts an end wall 62c in slot 62. The arm of cutting member 54 tapers from the width “W4” toward tines 68.

First end 54a of arm of cutting member 54 defines a hole 72 therein. Hole 72 is useful for hanging cutting member 54 on a hook on a storage rack or the like when cutting member 54 is disengaged from handle 52. It will be understood that instead of cutting members 54, 56, 58 being individually stored separately from handle 52, handle 52 may be configured to include a chamber (not shown) within which the cutting members 54-58 may be stored when not in use. Chamber may be such that a covering locks the cutting members 54-58 therein when not in use. Edge beveler 50 is used in the following manner. Referring to FIG. 3, cutting member 54 is initially not engaged with handle 52 and is shown in phantom in this figure. When the craftsman wishes to use cutting member 54, the first end 54a is inserted through opening 64 in first end 52c of handle 52 and pushed inwardly toward second end 52d. As first end 54a enters slot 62 it slides along the convexly curved surface of spring clip 66 depressing the same downwardly in a direction toward bottom wall 52b of handle 52. First end 54a is pushed inwardly until such longitudinal movement is arrested by shoulders 54c and end wall 62c. Spring clip 66 springs back somewhat toward its original position, thereby pushing first end upwardly in a direction toward the upper interior wall illustrated in FIG. 5. Spring clip thus traps first end 54a of cutting member 54 within slot 62 by way of spring tension. Edge beveler 50 may then be used to bevel the edge of a leather workpiece in a manner known in the art.

When the craftsman desires to use another one of the cutting members 56, 58 he or she will simply grasp the second end 54b and pull cutting member 54 out of slot 62 in the opposite direction to the way it was inserted into slot 62. The other one of the cutting members 56, 58 is then inserted through opening 64 and into slot 62 in the same manner as described with reference to cutting member 54. When the other cutting member 56, 58 is locked into handle by spring clip 66 the edge beveler is ready for use.

It will therefore be seen that edge beveler is converted from one size and style of beveler to another in a very rapid and easy manner. Additionally, the fabrication of the device is relatively inexpensive when compared with previously known edge bevelers that include inter-changeable cutting members. Still further, edge beveler 50 tends not to suffer from becoming looser over time as is the case with the chuck-type mechanism bevelers (such as shown in FIG. 2).

In accordance with an aspect of the invention there is disclosed a method of changing an edge beveler 50 comprising the steps of:
inserting a first end 54a of a first cutting member 54 through an opening 64 and into a slot 62 defined in a first end 52c of a handle 52 of an edge beveling tool 50;
pushing first cutting member 54 toward first end 52c of handle 52;
sliding first end 54a of first cutting member 54 through slot 62 and toward a second end 52d of handle 52;
depressing a spring clip 66 with first end 54a of first cutting member 54; and
urging, with spring clip 66, first end 54a of first cutting member 54 into engagement with an interior surface 52e of handle 52 which defines slot 62.

The method further comprising the steps of:
replacing first cutting member 54 with a second cutting member 56, where second cutting member 56 has a different cutting profile (the cutting surfaces between the tines thereof and possibly the spacing between the tines as well) to that of first cutting member 54.

The method wherein the step of replacing first cutting member 54 with second cutting member 56 includes the steps of:
pulling a second end 54b of first cutting member 54 in a direction away from first end 52c of handle 52;
sliding first end 54a of first cutting member 54 through slot 62 in a direction toward first end 52c of handle 52;
depressing spring clip 66 as first end 54a of first cutting member 54 slides through slot 62;
pulling second end 54b of first cutting member 54 until first end 54a thereof exits slot 62 through opening 64 in first end 52c of handle 52.

The method further comprises the steps of:
inserting a first end 56a of second cutting member 56 through opening 64 and into slot 62 defined in first end 52c of handle 52 of edge beveling tool 50;
pushing second cutting member 56 toward first end 52c of handle 52;
sliding first end 56a of second cutting member 56 through slot 62 and toward second end 52d of handle 52;
depressing spring clip 66 with first end 56a of second cutting member 56; and
urging, with spring clip 66, first end 56a of second cutting member 56 into engagement with interior surface 52e of handle 52 which defines slot 62.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. An edge beveling tool for working leather, said tool comprising:
a handle having a first end and a second end;
a cutting member comprising an arm having a first end and a second end;
one or more cutting surfaces provided on the second end of the cutting member; and
a spring assembly for removably engaging the cutting member with the handle.

2. The edge beveler as defined in claim 1, further comprising
a slot defined in the handle and having an opening thereto defined in the first end of the handle; and wherein the first end of the cutting member is configured to be received through the opening and into the slot.

3. The edge beveler as defined in claim 2, wherein the spring assembly is disposed within the slot and engages the first end of the cutting member when inserted into the slot.

4. The edge beveler as defined in claim 3, wherein the spring assembly comprises a spring clip.

5. The edge beveler as defined in claim 4, wherein the spring clip contacts the first end of the cutting member and urges the first end of the cutting member into contact with an interior surface of the handle which defines the slot.

6. The edge beveler as defined in claim 4, wherein the spring clip retains the first end of the cutting member in the slot by means of spring tension.

7. The edge beveler as defined in claim 2, wherein the cutting member further comprises at least one shoulder disposed a distance away from the first end of the cutting member; and wherein the arm of the cutting member has a width proximate the at least one shoulder that is greater than a width of the first end; and the width proximate the at least one shoulder substantially arrests movement of the cutting member into the slot.

8. The edge beveler as defined in claim 1 further comprising at least a second cutting member; and where the second cutting member is interchangeable with the first cutting member; and the second cutting member is substantially identical to the first cutting member except for a different cutting surface provided thereon; and wherein the second cutting member is engageable with the handle when the first cutting member is detached therefrom, and the spring assembly retains the second cutting member in engagement with the handle.

9. The edge beveler as defined in claim 1, wherein the handle has an exterior surface that is ergonomically designed to fit within a palm of a user's handle.

10. The edge beveler as defined in claim 9, wherein the handle has a convexly shaped top wall and a concavely shaped bottom wall.

11. The edge beveler as defined in claim 9, further comprising a textural element provided on the exterior surface of the handle.

12. The edge beveler as defined in claim 11, wherein the textural element comprises ridges or grooves which are applied on the exterior surface of the handle.

13. An edge beveling kit comprising:
a handle having a first end and a second end;
a first cutting member comprising an arm having a first end and a second end and one or more cutting surfaces provided on the second end of the cutting member;
a second cutting member comprising an arm having a first end and a second end; and wherein the first end of the second cutting member is substantially identical to the first end of the first cutting member; and wherein the second end of the second cutting member includes one or more cutting surfaces thereon; and wherein the second end of the first cutting member differs from the second end of the first cutting member; and
a spring assembly for selectively and removably engaging one or the other of the first and second cutting members with the handle.

14. The edge beveling kit as defined in claim 13, further comprising
a slot defined in the handle and having an opening thereto defined in the first end of the handle; and wherein the first ends of the first and second cutting members are configured to be received through the opening and into the slot.

15. The edge beveling kit as defined in claim 14, wherein the spring assembly is disposed within the slot and engages the first end of a selected on of the first and second cutting members when inserted into the slot.

16. The edge beveling kit as defined in claim 15, wherein the spring assembly comprises a spring clip and the spring clip contacts the first end of the selected on of the first and second cutting members and urges the first end thereof into contact with an interior surface of the handle which defines the slot.

17. A method of changing an edge beveler comprising the steps of:
inserting a first end of a first cutting member through an opening and into a slot defined in a first end of a handle of an edge beveling tool;
pushing the first cutting member toward the first end of the handle;
sliding the first end of the first cutting member through the slot and toward a second end of the handle;
depressing a spring clip with the first end of the first cutting member; and
urging, with the spring clip, the first end of the first cutting member into engagement with an interior surface of the handle which defines the slot.

18. The method as defined in claim 17, further comprising the step of:
replacing the first cutting member with a second cutting member, where the second cutting member has a different cutting profile to that of the first cutting member.

19. The method as defined in claim 18, wherein the step of replacing the first cutting member with the second cutting member includes the steps of:
pulling a second end of the first cutting member in a direction away from the first end of the handle;
sliding the first end of the first cutting member through the slot in a direction toward the first end of the handle;
depressing the spring clip as the first end of the first cutting member slides through the slot;
pulling the second end of the first cutting member until the first end thereof exits the slot through the opening in the first end of the handle.

20. The method as defined in claim 19, further comprising the steps of:
inserting a first end of the second cutting member through the opening and into the slot defined in the first end of the handle of the edge beveling tool;
pushing the second cutting member toward the first end of the handle;
sliding the first end of the second cutting member through the slot and toward the second end of the handle;
depressing the spring clip with the first end of the second cutting member; and
urging, with the spring clip, the first end of the second cutting member into engagement with the interior surface of the handle which defines the slot.
